(19) United States
(12) Patent Application Publication
(10) Pub. No.: US 2011/0050127 A1
(43) Pub. Date: Mar. 3, 2011

(54) LIGHTING DEVICE

(75) Inventors: Gerrit Overluizen, Eindhoven (NL); Ronald Van Rijswijk, Eindhoven (NL); Hendrik De Koning, Eindhoven (NL); Eefje Janet Hornix, Eindhoven (NL)

(73) Assignee: KONINKLIJKE PHILIPS ELECTRONICS N.V., Eindhoven (NL)

(21) Appl. No.: 12/990,514

(22) PCT Filed: Apr. 27, 2009
(86) PCT No.: PCT/IB2009/051707

§ 371 Date: Nov. 1, 2010

(30) Foreign Application Priority Data
May 8, 2008 (EP) 08155866.0

(51) Int. Cl. H05B 37/02; G02B 6/00

(52) U.S. Cl. 315/294; 362/551

(57) ABSTRACT

A lighting device (1401; 1402; 1403; 1404) comprises a semi-transparent plate-shaped light source (1409; 1400). The transparent plate-shaped light source may be a passive plate-shaped light source (1400) comprising a transparent light guide plate body (1410) with two substantially parallel main surfaces (1411; 1412), and wherein at least one of the main surfaces (1411; 1412) is provided with permanent obtrusions (1415). The obtrusions (1415) may be implemented as material portions projecting from the surface and/or as indentations recessed in the surface. The obtrusions (1415) may be arranged by sandblasting, preferably in a pattern of dots, wherein the dots may have sizes in the range between 20 and 200 μm, preferably approximately 100 μm, and wherein the dot density may be in the range between 5 and 500 dots/cm².

### FIELD OF THE INVENTION

The present invention relates in general to a lighting device, suitable for providing light for purposes of illumination and/or for ornamental or decorative purposes.

### BACKGROUND OF THE INVENTION

Lighting devices in general are known. They typically comprise one or more light-generating elements mounted in a housing, provided with shielding means. The light-generating elements may be of incandescent type, gas discharge type, LED type, etc. In the case of incandescent type, the actual light-generating element is the glowing wire, and the surrounding glass bulb is actually a shielding member. Apart from that, a lamp armature may comprise further shielding members, also indicated as “cap” or the like, which function to mechanically shield the light-generating element from damage, but which also function to prevent a direct view of the light-generating element. In many lighting devices, such shielding member receives the light from the light-generating element and distributes it into the surroundings, by reflection and/or scattering. As such, the shielding member may be termed a passive light source or secondary light source, the actual light-generating element being an active light source or primary light source.

It is an object of the invention to provide a lighting device of a new design. Particularly, the present invention aims to provide a lighting device which, when the lighting device is OFF, is substantially transparent.

### SUMMARY OF THE INVENTION

According to an important aspect of the invention, the lighting device comprises a semi-transparent plate-shaped light source. The plate-shaped light source may be a primary light source, i.e. an actual light-generating element. The plate-shaped light source may alternatively be a secondary light source, provided with one or more primary light sources arranged adjacent one or more of its side edges, wherein the light from the primary light sources travels mainly parallel to the main surfaces of the plate-shaped light source until it is coupled out through at least one of the main surfaces. In both cases, the plate-shaped light source can be operated in an OFF state in which the plate-shaped light source is substantially transparent, or in an ON state in which the plate-shaped light source emits light having at least a component in a main direction substantially perpendicular to a main surface of the plate-shaped light source. It is noted that the light may be emitted in random directions.

In a preferred embodiment, the plate-shaped light source further comprises a reflective member disposed at one side, for reflecting a portion of the emitted light back through the plate-shaped light source. This would increase the illumination level at the other side of the plate-shaped light source.

According to the invention, the higher the reflectivity of the reflective member the better the light output of the plate-shaped light source. However, when the light source is OFF, it should preferably be completely transparent such as to be virtually invisible, but increased reflectivity typically involves reduced transmissivity. The invention further aims to reduce this problem. Specifically, the present invention aims to providing embodiments of the lighting device which have good performance in the illumination effect when the lighting device is ON and have good performance in transmitting light when the lighting device is OFF.

In a preferred embodiment, the plate-shaped light source is provided with a scattering layer, arranged to scatter a portion of the light which falls on the scattering layer. With scattering is meant that light is directed in random directions. Scattering also comprises diffuse reflection. In the case of the plate-shaped light source being a secondary light source, provided with one or more primary light sources arranged adjacent one or more of its side edges, the scattering layer may be optically coupled to the plate-shaped light source to assist in coupling out of light.

Further advantageous elaborations are mentioned in the dependent claims.

It is noted that the scattering layer does not only scatter light emitted by the plate-shaped light source but may also scatter a portion of the ambient light which falls on the scattering layer. In a particular embodiment of the lighting device according to the invention, the scattering layer is comprised in a scattering device further comprising electrical means for controlling the amount of scattering by the scattering layer. This embodiment of the lighting device according to the invention comprises a so-called active scattering layer. The amount of light scattering by the scattering layer is preferably related to a voltage difference across the scattering layer, which is created by electrodes at opposite sides of the scattering layer. Preferably the electrodes are highly transparent and may comprise indium tin oxide (ITO) but can occasionally also be indium zinc oxide (IZO) also known to those skilled in the field as a transparent electrode. Preferably the square resistance of the transparent electrodes is sufficiently low to minimize the required voltage between the two electrodes needed to switch between different states.

Preferably the scattering device is arranged to switch between a first state in which hardly any scattering of light takes place and a second state in which the scattering of light is relatively strong. Typically, the first state corresponds to the turned OFF state of the lighting device while the second state corresponds to the turned ON state of the lighting device. Preferably, a voltage difference across the scattering layer is minimal for the second state resulting in no energy consumption during the periods in which the lighting device is turned off.

In a particularly preferred embodiment, the scattering device is a switchable device and the reflective member is a switchable device, wherein the scattering device and the reflective member are switched simultaneously.

In another embodiment of the lighting device according to the invention, the scattering layer is a scattering polarizer, which is substantially transmissive for light having a first polarization direction and which is arranged to scatter the portion of the ambient light having a second polarization direction being orthogonal to the first direction. This embodiment of the lighting device according to the invention comprises a so-called passive scattering layer, meaning that the amount of scattering is predetermined and cannot be controlled during operation of the lighting device. A scattering polarizer is a material which has different behavior for respective polarization directions. The scattering polarizer is substantially transparent for light having a first polarization direction and is arranged to scatter light having a second polarization direction which is orthogonal with the first polarization direction. An example of the scattering polarizer is described in the PhD thesis of Henri Jagt, “Polymeric polarization optics for energy efficient liquid crystal display illumination”, 2001, Chapter 2 and in patent application WO01/90637.

In an embodiment of the lighting device according to the invention, the reflective layer is a semi transparent mirror.

In another embodiment of the lighting device according to the invention, the reflective layer is a polarizer which is substantially transparent for the display light having a first polarization direction. The reflective polarizer can be a stack of alternating birefringent and non-birefringent layers in a periodicity that enables Bragg reflection for the second polarization direction and provides transmission for the orthogonal, i.e. first polarization direction. An example of a reflective polarizer that is based on this principle is a polarizer film supplied by 3M company under the name of Vikuity™ Dual Brightness Enhancement Films (DBEF).

Another way of making reflective polarizers is based on cholesteric films as described in U.S. Pat. No. 5,506,704, U.S. Pat. No. 5,793,456, U.S. Pat. No. 5,948,831, U.S. Pat. No. 6,193,937 and in ‘Wide-band reflective polarizers from cholesteric polymer networks with a pitch gradient’, D. J Broer, J. Lub, G. N. Mol, Nature 378 (6556), 467-9 (1995). In combination with a quarter wave film this film provides the same optical function as DBEF.

Alternatively the reflective polarizer is based on the so-called wire grid principle where narrow periodic lines of a metal with a periodicity smaller than the wavelength of light are applied on a glass or plastic substrate.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1A shows a front view of an embodiment of the lighting device when the plate-shaped light source is turned ON;

FIG. 1B shows the front view of the embodiment of the lighting device of FIG. 1A when the plate-shaped light source is turned OFF;

FIG. 2 schematically shows an embodiment of the lighting device according to the invention;

FIG. 3 schematically shows an embodiment of the lighting device according to the invention comprising an absorption polarizer disposed between the scattering layer and the reflection layer;

FIG. 4 schematically shows an embodiment of the lighting device according to the invention comprising an absorption polarizer disposed in front of the scattering layer;

FIG. 5 schematically shows a scattering polarizer;

FIG. 6 schematically shows a scattering device comprising the scattering layer;

FIG. 7 schematically shows an embodiment of the lighting device according to the invention comprising additional light sources at the borders of the scattering layer;

FIG. 8 is a schematic cross-section of a lighting device;

FIGS. 9A and 9B are schematic cross-sections of embodiments of a lighting device according to the present invention;

FIGS. 10A and 10B schematically illustrate preferred details of the lighting device;

FIG. 11A schematically illustrates a plate-shaped light source;

FIG. 11B is a figure comparable to FIG. 9A, schematically illustrating a lighting device with a plate-shaped light source according to FIG. 11A;

FIG. 11C is a figure comparable to FIG. 9B, schematically illustrating a lighting device with a plate-shaped light source according to FIG. 11A;

FIGS. 12A-12D schematically illustrate different embodiments of lighting devices;

FIG. 13 shows a graph illustrating decline of luminance over a lighting device;

FIG. 14 schematically shows a block diagram of a lighting device with a graph schematically illustrating luminance for different segments of a scatterer;

FIGS. 15A-B schematically illustrate different embodiments of lighting devices.

The Figures are diagrammatic and not drawn to scale.

### DETAILED DESCRIPTION OF THE INVENTION

In the following, first a description will be given of certain aspects of a scattering layer and a reflective member.

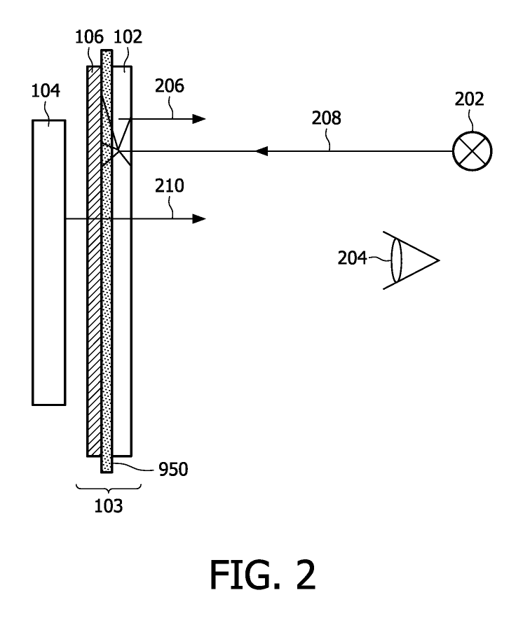

FIG. 2 schematically shows a side view of a lighting device 103 arranged in front of an object 104, which lighting device 103, in this embodiment, comprises a scattering layer 102 and a reflective member 106 on opposite sides of a plate-shaped light source 950. A viewing person is schematically indicated at 204. In the following, a direction from the lighting device 103 towards the viewing person 204 will be indicated as a first direction. An ambient light source 202 generates ambient light 208. The scattering layer 102 is arranged for scattering a portion of the ambient light 208 and a portion of the light emitted by the plate-shaped light source 950. The reflective member 106, which is located behind the plate-shaped light source 950 as seen from the viewer 204, is arranged for reflecting a portion of the scattered ambient light 206 and a portion of the light emitted by the plate-shaped light source 950 into the first direction.

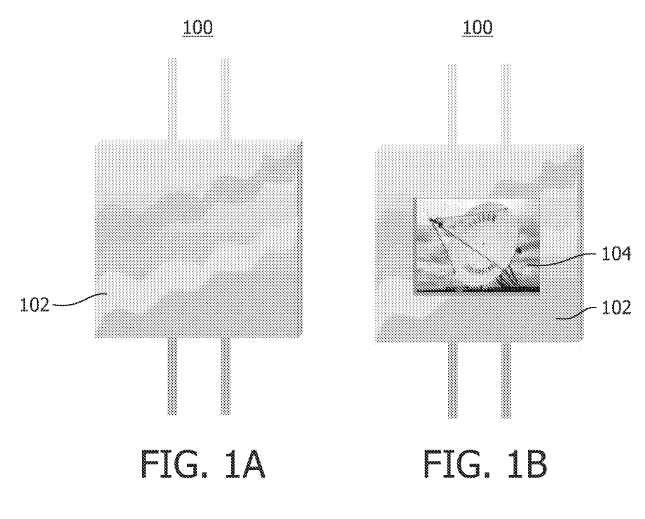

FIG. 1A shows a front view of lighting device 103 when the plate-shaped light source 950 is turned ON. Basically, the viewer 204 sees a preferably flat surface with dimensions that are equal to the respective dimensions of the scattering layer 102. The scattering layer 102 may be homogeneous in color, i.e. may have a single color. Preferably, the scattering layer 102 has multiple colors representing a predetermined texture. That means that at a first region of the scattering layer 102 a dye with a first color is located while at a second region of the scattering layer 102 a dye with a second color is located.

FIG. 1B shows the front view of this lighting device when the plate-shaped light source 950 is turned OFF. Now the lighting device is substantially transparent and light 210 (see FIG. 2) originating from the object 104 in the first direction passes the scattering layer 102 and can be observed by the viewer 204 that is located in front of the lighting device. In other words, the viewer 204 can view through the lighting device. Preferably, the lighting device according to the invention is arranged to reduce the amount of scattering of ambient light when the plate-shaped light source 950 is turned OFF.

Thus, the viewer 204 is provided with:

light which originates from the object 104, which moves in the first direction towards the viewer 204; and/or

scattered light 206 which originates from the ambient light source 202 (direct and/or indirect) and the plate-shaped light source 950, and which is scattered by the scattering layer 102 and optionally reflected by the reflection layer 106.

The scattering layer 102 may be comprised in a scattering device 600 (see FIG. 6) which is arranged to limit the amount of scattered ambient light 206 under predetermined conditions. Alternatively, the scattering layer 102 is passive.

In conjunction with the figures it is disclosed that several types of polarizers may be applied. With a polarizer is meant an optical element which filters a light ray depending on the polarization directions of the respective components of the light ray. Typically, a polarizer is substantially transmissive for components of the light ray having a first polarization direction while the polarizer is substantially influencing components of the light ray having a second polarization direction, which is orthogonal with the first polarization direction. Influencing in this context comprises scattering and absorbing.

Various polarizers may be used for the following functions:

in an embodiment of the lighting device according to the invention a polarizer is used as scattering layer 102;

in an embodiment of the lighting device according to the invention a polarizer is used as reflecting layer 106.

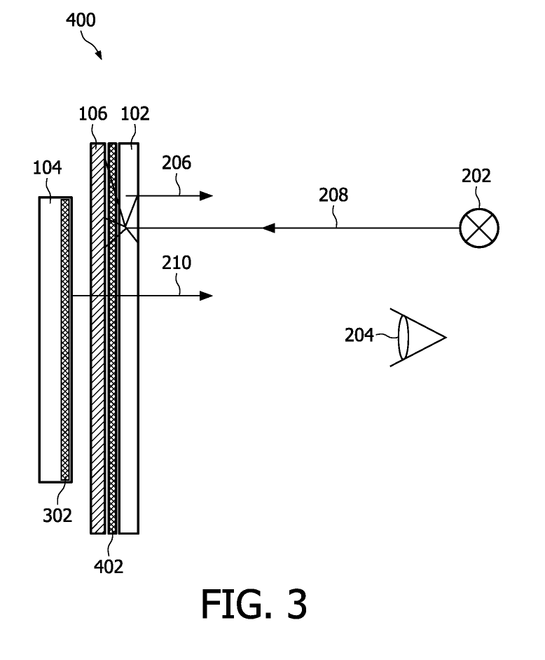

FIG. 3 schematically shows an embodiment of the lighting device 400 according to the invention comprising an absorption polarizer 402 disposed between the scattering layer 102 and the reflection layer 106. The absorption polarizer 402 is arranged to absorb a portion of the scattered ambient light 206. More precisely, the absorption polarizer 402 may be arranged to absorb the components of the ambient light having the second polarization direction. The reason is as follows.

Because of the scattering and reflection of ambient light by the lighting device of the invention, the viewer 204 receives reflected ambient light. By applying an absorption polarizer 402, as optical absorption means 402, in front of the reflection layer 106 the reflection can be reduced. To achieve the required effect, the absorption polarizer 402 is arranged to absorb the components of the scattered ambient light 206 having the second polarization direction which would have been reflected by the reflective layer 106. Preferably, the reflective layer 106 is also based on a polarizer.

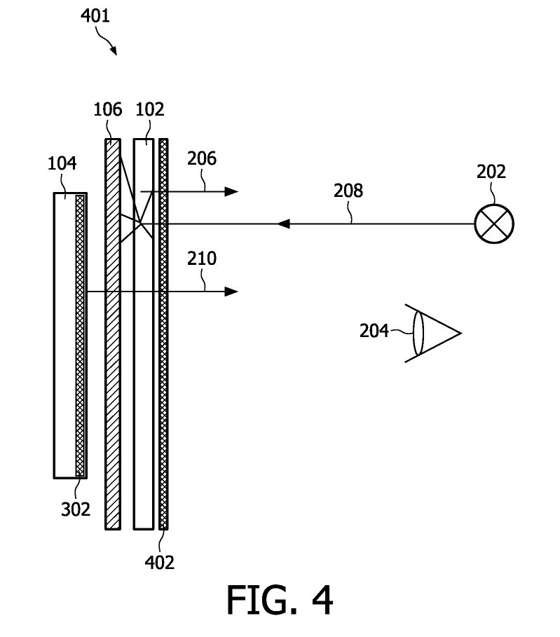

FIG. 4 schematically shows an embodiment of the lighting device 401 according to the invention comprising an absorption polarizer 402 disposed in front of the scattering layer 102. This embodiment of the display apparatus 401 is substantially equal to the embodiment of the display apparatus 400 as described in connection with FIG. 3. The difference is the position of the absorption polarizer 402.

Preferably, the absorption polarizer 402 as described in connection with FIGS. 3 and 4 is a switchable absorption polarizer. The function and position of the switchable absorption polarizer corresponds to what is disclosed in patent application WO03/079318 as filed by the same applicant.

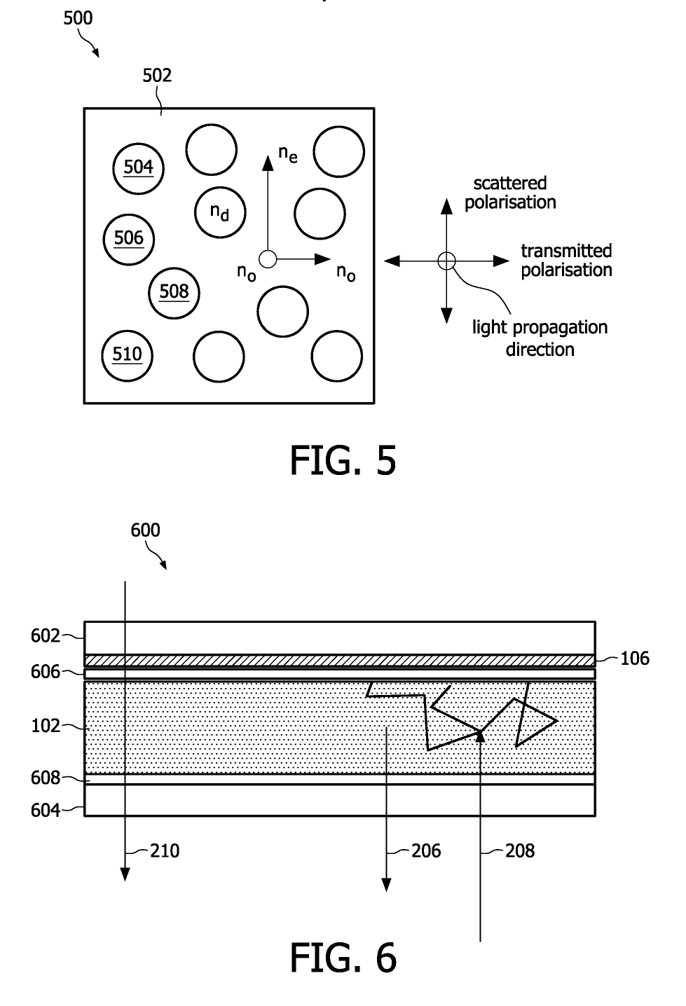

FIG. 5 schematically shows a scattering polarizer 500. A scattering polarizer 500 is a material which has different behaviors for respective polarization directions. The scattering polarizer is substantially transparent for light having a first polarization direction D1 and is arranged to scatter light having a second polarization direction D2 which is orthogonal with the first polarization direction D1. An example of the scattering polarizer is described in the PhD thesis of Henri Jagt, “Polymeric polarization optics for energy efficient liquid crystal display illumination”, 2001, Chapter 2 and in patent application WO01/90637.

A scattering polarizer 500 can be based on particles 504-510 embedded in a polymer matrix 502. Blending small particles 504-510 with a known polymer 502 like e.g. PEN or PET, followed by extrusion of this mixture to a foil and stretching this foil, makes the scattering polarizer 500. The stretching provides uniaxial orientation, making it transparent for the first polarization direction D1 whereas it is scattering for the orthogonal second polarization direction D2.

The principle of the scattering polarizer 500 is as follows. The small particles 504-510, depicted as white circles, correspond to a dispersed phase with reflective index nd in a uniaxialy oriented polymer matrix 502 with a first polymer reflective index no for light having a first polarization direction D1 and a second polymer reflective index ne for light having a second polarization direction D2. The refractive index n_{d} of the particles 504-510 is matched to the first polymer refractive index nₒ, whereas the second polymer refractive index nₑ>>n_{d}.

The scattering polarizer 500 may be based on small particles embedded in a non-colored stretched foil. The particles may be e.g. core-shell particles (Rohm and Haas, Paraloid EXL 3647) having a diameter of 200 nm and consisting of a styrene-butadiene (S-BR) rubbery core and a poly(methylmethacrylate) (PMMA) shell. In order to add color, a dye or pigment can be added either to the particles 504-510 or to the polymer matrix 502. When the dye is added to the polymer matrix 502 also a dichroic dye can be selected that orient itself with the aligned polymer matrix 502 such that especially the polarization parallel to the stretching direction becomes colored, but the scattering polarizer 500 remains transmissive for first polarization direction D1.

Rather than using spherical particles the particles might have also other shapes, for instance elongated. In one embodiment the particles have a fiber-like shape obtained by melting and elongation of the initially spherical particles during the stretching process of the polymer matrix material.

As explained above, a scattering polarizer 500 may be applied as scattering layer 102 or as reflecting layer 106. Optionally, an embodiment of the lighting device according to the invention comprises a single scattering polarizer 500 which both fulfils the scattering and reflection function, i.e. the scattering layer 102 and the reflecting layer 106 are both realized by a single scattering polarizer 500.

FIG. 6 schematically shows a scattering device 600 comprising a scattering layer 102. A scattering device 600 is arranged to control the amount of scattering of light by the scattering layer 102. The scattering device 600 comprises:

a set of substantially flat substrates 602-604, e.g. based on glass, PMMA or some other substantially transparent material;
a set of electrical conductors 606-608 adjacent to the respective substrates 602-604 acting as electrodes for applying a voltage difference. The electrical conductors are substantially transparent and preferably based on ITO; and

a scattering layer 102 being sandwiched by the set of electrical conductors 606-608.

The scattering layer 102 preferably comprises Polymer Dispersed Liquid Crystals (PDLC), Cholesteric Texture Liquid Crystals (CTLC), Liquid Crystal (LC) gels or polymer network Liquid Crystal (PNLC). By applying the appropriate voltage difference on the electrical conductors 606-608, i.e. across the scattering layer 102, the orientation of the liquid crystals can be modified, resulting in an increase or decrease of the amount of light scattering by the scattering layer 102.

To indicate the function of the scattering device 600 in the lighting device according to the invention, the direction of the light 210 originating from the object 104 behind the lighting device, the direction of the ambient light 208 and the direction of the light emitted by the plate-shaped light source 950 and scattered ambient light 206 are depicted.

In order to advantageously obtain a device as thin as possible, it is preferred that the distance between the reflecting layer 106 and the scattering layer 102 is as small as possible. The scattering device 600 as depicted in FIG. 6 comprises the reflecting layer 106. This is a so-called in-cell configuration. The reflecting layer 106 could be the electrode (as in wire grids). It should be noted that the reflecting layer 106 is optional for the scattering device 600. That means that a scattering device not including the reflecting layer 106 but being adjacent to the reflecting layer 106 could also be applied in an embodiment of the lighting device according to the invention. To fulfill the requirements of having a relatively small distance between reflective layer 106 and the scattering layer 102 and the reflective layer 106 being not included in the scattering device, the substrate 602 which is adjacent to the reflective layer 106 must be relatively thin. Preferably, a reflective index matching fluid, i.e. glue is applied to realize the optical contact between the reflective layer 106 and the scattering device 600.

If for ornamental design reasons it is desired to switch the scattering layer 102 partially, e.g. over a surface area corresponding to only a portion of the scattering device 600, the substrates 602-604 of the scattering device 600 may contain patterned electrodes. The patterned electrodes can be use to open and close the light scattering area in a discrete way. But it may also be used to open the lighting area only partially or to apply a gradient in illumination power.

The scattering device 600 may be configured to vary the size and/or dimensions of said partial surface area with time.

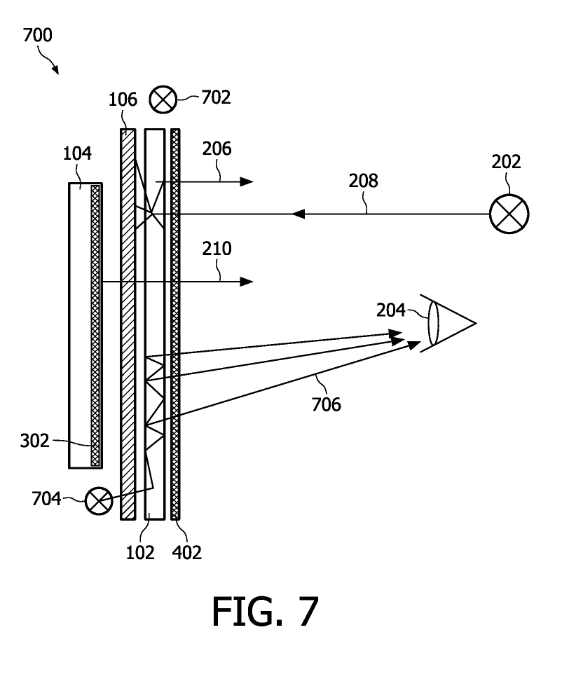

FIG. 7 schematically shows an embodiment of the lighting device 700 according to the invention, comprising additional light sources 702-704 at the borders of the scattering layer 102. This embodiment of the lighting device 700 according to the invention is arranged to emit light being generated by the light additional light sources 702-704 by means of the scattering layer 102. That means that light from the additional light sources 702-704 is coupled into the scattering layer 102, scattered by the scattering layer 102 and subsequently emitted at several locations at the surface of the scattering layer 102. A portion of that light 706 will be emitted in the first direction, i.e. towards the viewer 204.

The operation of the light sources 702-704 may be simultaneous with the operation of the plate-shaped light source 950. The result is an increased amount of the light. Preferably, the scattering device 600 is also controlled simultaneously with the operation of the plate-shaped light source 950.

In FIG. 7 two additional light sources 702-704 are depicted, being located at respective borders of the scattering layer 102. A first one of the additional light sources 704 is located behind the scattering layer 102, while a second one of the additional light sources 702 is located more distant.

Preferably, multiple light sources 702-704 being arranged to generate light with mutually different colors are used.

In the above, the basic concept behind the present invention has been explained. In the following, some further preferred elaborations will be explained.

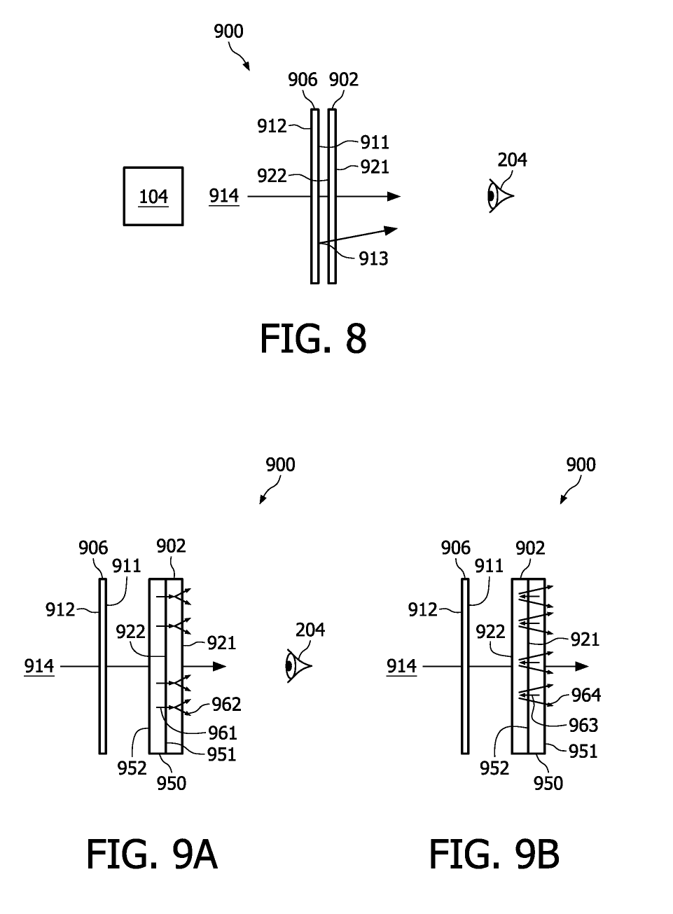

FIG. 8 is a schematic cross-section of some features of a lighting device 900. The device 900 comprises a reflective member 906 and a scattering device 902. The reflective member 906 has a planar shape of substantially uniform thickness. A first surface of the reflective member 906 which in use will be directed to a viewing person 204 will be indicated as front surface 911. A second surface opposite the first surface 911 will be indicated as back surface 912 of the reflective member 906. Likewise, the scattering device 902 has a front surface 921, which in use will be directed to a viewing person 204, and a back surface 922 directed away from the viewing person 204.

According to the present invention, the lighting device 900 comprises a substantially transparent, plate-shaped light source 950, arranged in parallel to the scattering layer 902 and preferably not optically coupled to the scattering layer 902. The plate-shaped light source 950 has a front surface 951 which in use will be directed to a viewing person 204, and a back surface 952. In the embodiment illustrated in FIG. 9A, the plate-shaped light source 950 is arranged at the back-side of the scattering layer 902, i.e. the front surface 951 of the plate-shaped light source 950 is adjacent the back surface 922 of the scattering layer 902. In the embodiment illustrated in FIG. 9B, the plate-shaped light source 950 is arranged in front of the scattering layer 902, i.e. the back surface 952 of the plate-shaped light source 950 is adjacent the front surface 921 of the scattering layer 902.

The operation is as follows. When the lighting device 900 is in its ornamental or illuminating state, the plate-shaped light source 950 is switched ON. In the case of the FIG. 9A, light emanating from the plate-shaped light source 950 will be coupled into the scattering layer 902, over the entire surface of the scattering layer 902, as illustrated by arrows 961, and is scattered forward by the scattering layer 902 towards the viewer 204, as illustrated by arrows 962. In the case of the FIG. 9B, light emanating from the plate-shaped light source 950 will be coupled into the scattering layer 902, over the entire surface of the scattering layer 902, as illustrated by arrows 963, and is scattered back by the scattering layer 902 through the transparent plate 950 towards the viewer 204, as illustrated by arrows 964. As a result, in both cases, the viewer 204 will observe the scattering layer 902 as having a slightly milky appearance, emitting light.

It is noted that in the case of FIG. 9A, any light rays directed from the plate-shaped light source 950 towards the reflective member 906 will be largely reflected back by the reflective member 906, pass the plate 950 in view of its transparency, and enter the scattering layer 902 to thus contribute to the scattering. It is further noted that in the case of FIG. 9B, any light rays passing the scattering layer 902 to reach the reflective member 906 will be largely reflected back by the reflective member 906 and re-enter the scattering layer 902 to thus contribute to the scattering.

The embodiment illustrated in FIG. 9A has an advantage over the embodiment illustrated in FIG. 9B in that it is more robust against unwanted forward scattering, as may be caused for instance by dust particles on the outer front surface.

When the lighting device is OFF, the scattering layer 902 may be switched to a non-scattering state, so that the viewer 204 is not hindered by scattered light 962, 964. Light 914 from the object 104 will not be obstructed by the plate-shaped light source 950 because of its transparency.

It is noted that it is possible to omit the reflective member 906 entirely.

The plate-shaped light source 950 may be suitably implemented as a passive plate having scattering properties and being provided with one or more light sources arranged along its perimeter. Preferably, the plate-shaped light source 950 is switchable between two states, i.e. a scattering state and a non-scattering state, so that the scattering properties can be switched off in order to minimize disturbances when the screen 104 is ON.

However, it is also possible that the plate-shaped light source 950 is implemented as an active light source, actually generating light itself. By way of example, the plate-shaped light source 950 may be implemented using organic LEDs.

Preferably, the scattering layer 902 is a switchable layer having two states, i.e. a scattering state and a non-scattering state in which the layer 902 is substantially transparent.

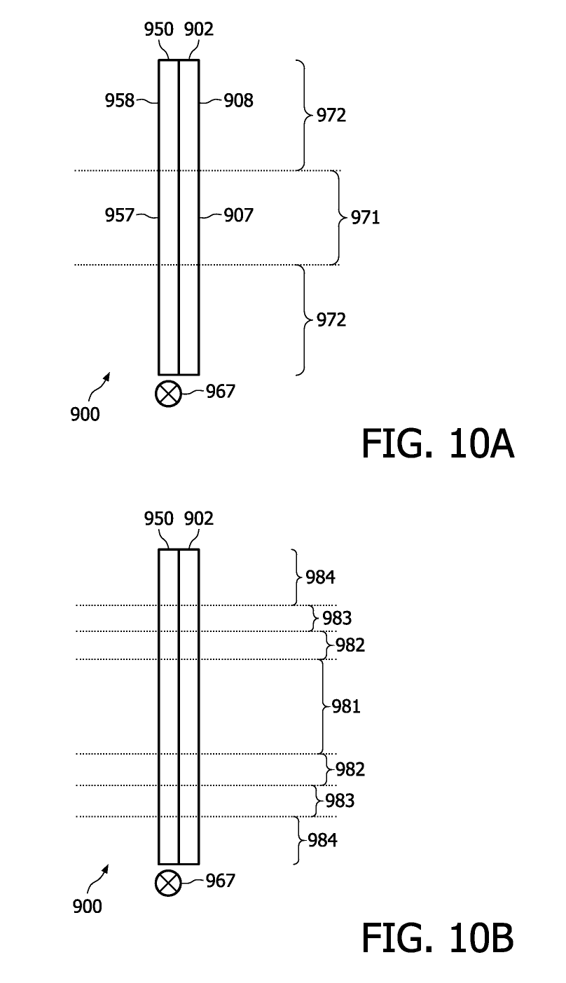

Special ornamental effects will be described with reference to FIGS. 10A-B. FIG. 10A schematically illustrates a preferred embodiment of a lighting device 900, in the embodiment of FIG. 9A, although it should be clear that the following also applies to the embodiment of FIG. 9B. The figure shows that the lighting device 900 comprises a central part 971 and a peripheral part 972 outside the central part. Corresponding central parts of the plate-shaped light source 950 and the scattering layer 902 will be referred to as central part 957 of the plate-shaped light source 950 and central part 907 of the scattering layer 902, respectively. Corresponding peripheral parts of the plate-shaped light source 950 and the scattering layer 902 will be referred to as peripheral part 958 of the plate-shaped light source 950 and peripheral part 908 of the scattering layer 902, respectively.

In an ornamental mode, the entire lighting device 900 is producing scattered light 962 or 964 towards the viewer 204, i.e. both the peripheral part 972 and the central part 971. The backside of the peripheral part 972, i.e. the outer surface directed away from the viewer 204, may be provided with a black layer.

In another ornamental mode, the user may desire a white (or whitish) frame around a central transparent portion. To allow for such possibility, the central part 971 of the lighting device 900 is switched off but the peripheral part 972 of the lighting device 900 remains switched on. Particularly, light sources 967 arranged along the edges of the plate-shaped light source 950 remain switched on, and the central part 907 of the scattering layer 902 is switched to its non-scattering state while the peripheral part 908 of the scattering layer 902 is switched to its scattering state. If the plate-shaped light source 950 is an active light source, its central part 957 and peripheral part 958 are preferably capable of being switched on/off independently from each other, so that in this case the central part 957 is switched off while the peripheral part 958 is switched on.

It may be preferred that such white frame can have various sizes. Thus, the lighting device 900 preferably has multiple sections 981, 982, 983, 984, etc, as illustrated in FIG. 10B, capable of being switched on/off independently from each other, which can as desired be combined to constitute central part 971 or peripheral part 972.

It is noted that it is possible to use the lighting device as a flat lamp.

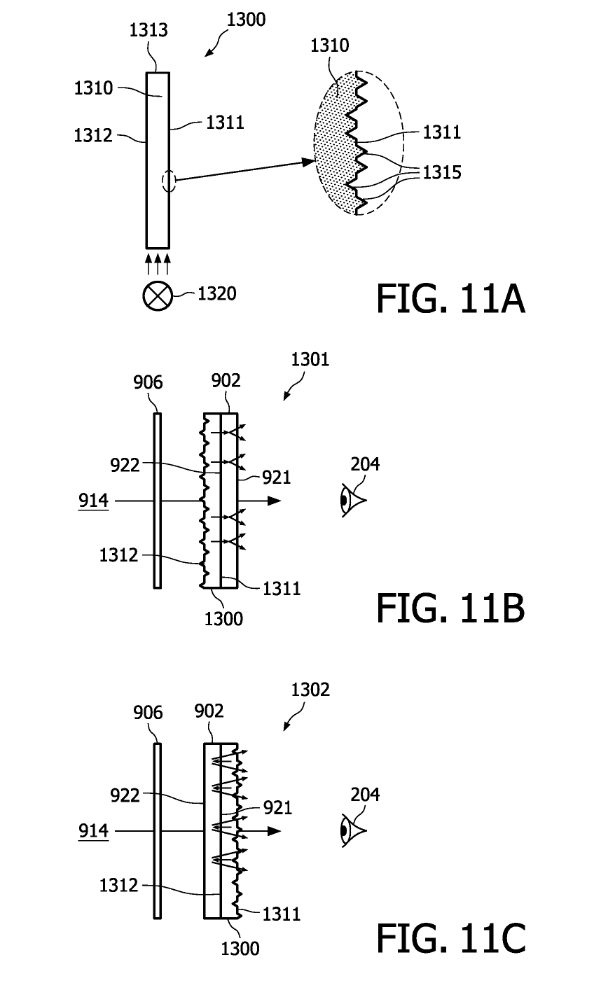

FIG. 11A schematically illustrates, as a further elaboration of the present invention, a particularly advantageous embodiment of a substantially transparent, plate-shaped light source, indicated by reference numeral 1300, suitable to be used as the light source 950 mentioned above. The light source 1300 is implemented as a transparent light guide plate body 1310 with two substantially parallel main surfaces 1311, 1312 and a circumferential side face 1313. The plate body 1310 may for instance have a rectangular contour, in which case the side face comprises, in its upright condition shown in the figure, a lower face, upper face, lefthand face and righthand face. As far as light generation is concerned, the light guide plate body 1310 is typically passive, although it is possible that an active material is used.

It is noted that, basically, any plate-shaped transparent material with mutually parallel surfaces is suitable for use as a light guide plate.

The light source 1300 further comprises at least one active light generating element 1320, arranged at a predetermined location near the side face 1313 of the light guide plate body 1310. The active light generating element 1320 is advantageously implemented as a LED, but another embodiment, such as for instance a gas discharge tube, is also possible. If FIG. 11A is a side view, the figure shows the active light generating element 1320 located near the lower face part of the side face 1313. The side face 1313 of the light guide plate body 1310 is finished such that light from the light generating element 1320 enters the light guide plate body 1310 easily with little or no reflection.

For obtaining illumination properties, the light guide plate body 1310 should, as mentioned earlier, have scattering properties, i.e. light should be coupled out of at least one of the main surfaces 1311, 1312, in a direction having a component perpendicular to the main surfaces 1311, 1312. For providing suitable scattering properties, the present invention proposes that at least one of the main surfaces 1311, 1312 is provided with permanent unevennesses or obtrusions 1315. The obtrusions 1315 may be implemented as material portions projecting from the surface 1311 (haut relief) or as indentations recessed in the surface (bas relief).

FIG. 11B is a figure comparable to FIG. 9A, schematically illustrating a lighting device 1301 comparable to the device 900 of FIG. 9A where the plate-shaped light source 950 is replaced by the light source 1300. Here, the light guide plate body 1310 has its front surface 1311 directed to the back surface 922 of the scattering device 902. Here it is the back surface 1312 of the light guide plate body 1310 that is provided with the obtrusions.

FIG. 11C is a figure comparable to FIG. 9B, schematically illustrating a lighting device 1302 comparable to the device 900 of FIG. 9B where the plate-shaped light source 950 is replaced by the light source 1300. Here, the light guide plate body 1310 has its back surface 1312 directed to the front surface 921 of the scattering device 902. Here it is the front surface 1311 of the light guide plate body 1310 that is provided with the obtrusions.

Thus, the main surface with obtrusions is directed away from the scattering device 902. It is noted that in the above cases the scattering device 902 is preferably located close to, possibly even in contact with the plate-shaped light source 950, yet without being optically coupled, in situations where the combination of scattering protrusions and optically coupled would results in an outcoupling efficiency so high that it is difficult to achieve sufficient light intensity over the entire surface of the disguising device.

The obtrusions provide the scattering properties to the plate body 1310, or add to such properties. Thus, depending on the distribution over the corresponding surface 1311, 1312, said obtrusions improve the uniformity and efficiency of the lighting device 1302, 1301 in the situation when the light generating element 1320 is ON and the lighting device 1302, 1301 is in its ornamental state.

The obtrusions 1315 may be distributed evenly and uniformly over the corresponding surface 1311, 1312. However, it is also possible that the obtrusions 1315 are distributed according to a certain pattern to define a graphical image, for instance a photo. The obtrusions 1315 may be implemented as a dot pattern, wherein the density and/or size of the dots may vary over the surface 1311, 1312. An example of a suitable method for providing the obtrusions 1315 is sandblasting, wherein a mask may be used to provide the desired variation of density or other decoration preferences.

It is noted that Japanese patent application 1999-223805 to Nissha Printing Co Ltd, publication number 2001-052519, discloses the use of a light guide plate as a backlight for a display. The light guide plate comprises two non-parallel surfaces, one surface being provided with non-mirror projections having a diameter of less than 20 μm and having a cross-sectional shape according to a part of a circle. Adjacent the light guide plate, facing the projections, the device comprises a mirror plane. Light is inputted at a side of the plate, and partially outputted by the projections. Light outputted by a projection is reflected by the mirror, passes the width of the light guide plate and is finally outputted at the surface opposite the projections. Such device is not transparent in the OFF state, and is therefore not suitable as a transparent lighting device in accordance with the principles of the present invention.

In a specific experimental embodiment, the plate body 1310 was made from glass and the obtrusions were made by sandblasting in a dot pattern. The size of the dots (diameter of substantially circular dots) was varied, and the density of the dots was varied.

It was found that undesirable visibility in the OFF state increases with increasing dot size. In this respect, dot sizes larger than 0.4 mm were found to involve undesirable visibility, so that dot sizes smaller than 0.4 mm are preferred. In general, the preferred range of dot sizes is between 20 and 200 μm, which sizes can well be achieved using sandblasting. Dot sizes of approximately 0.1 mm were found to give very satisfying results. Smaller dot sizes may also give good results, and may even be preferred in view of reduced visibility, but it is more difficult to make predefined patterns in view of the necessity to use a mask.

Further, it was found that the dot density greatly influences the luminance of the plate-shaped light source 1300, and hence the illumination performance in the ON state. When a region of the plate body 1310 has higher dot density, more light is coupled out of the plate body 1310, so a higher local luminance and better illumination performance is achieved in that region. On the other hand, because more light is coupled out, less light remains beyond such region, so the luminance at larger distances from the light generating element 1320 may be reduced, reducing the illumination performance in the ON state. For a dot size of 0.1 mm, a dot density in the range between 5 and 500 dots/cm² appeared to provide a suitable tradeoff.

In the above, lighting devices have been described comprising a combination of a reflective member and a scattering layer, wherein the scattering layer is provided with a plate-shaped light source. All in all, the combination of the scattering layer and the plate-shaped light source serves to provide a diffuse glare of light over the area of the lighting device. Both the scattering layer and the plate-shaped light source serve basically different purposes. Starting from the plate-shaped light source, which provides more or less diffuse light, the scattering layer serves to further scatter this light and make it even more diffuse and further increases luminance by scattering ambient light. However, with a suitable design it is possible that the illumination performance of the plate-shaped light source by itself is already sufficient so that the separate scattering layer may be omitted.

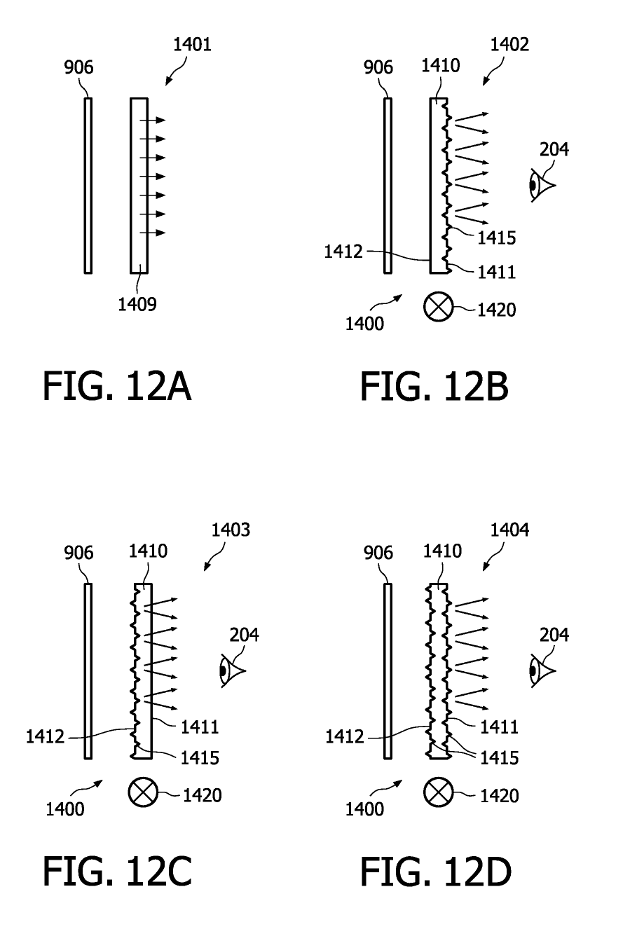

The above applies for an active plate-shaped light source, for instance implemented by using organic LEDs or by inorganic thin film electroluminescence layers, but also for a passive plate-shaped light source, such as described for instance with reference to FIGS. 11A-11C. Based on this understanding, FIGS. 12A-12D schematically illustrate lighting devices where the separate scattering layer is omitted.

In FIG. 12A, a lighting device 1401 comprises the combination of a reflective member 906 with an active plate-shaped light source 1409.

In FIG. 12B, a lighting device 1402 comprises the combination of a reflective member 906 with a passive plate-shaped light source 1400 comprising a plate body 1410 having obtrusions 1415 at its front surface 1411 directed towards an observer 204. A device having such orientation has a higher light efficiency as compared to the device of FIG. 12C. In FIG. 12C, a lighting device 1403 comprises the combination of a reflective member 906 with a passive plate-shaped light source 1400 comprising a plate body 1410 having obtrusions 1415 at its back surface 1412 directed away from an observer 204. A device having such orientation is more robust against pollution as compared to the device of FIG. 12B.

In FIG. 12D, a lighting device 1404 comprises the combination of a reflective member 906 with a passive plate-shaped light source 1400 comprising a plate body 1410 having obtrusions 1415 both at its front surface 1411 and at its back surface 1412. Thus, the advantages of the embodiments 1402 and 1403 are combined. Further, it is possible to obtain special effect by arranging the obtrusions at the two different surfaces 1411 and 1412 in mutually different patterns.

In the embodiments 1402, 1403, 1404, a light-generating element is always indicated at 1420. For the plate body 1410 and the obtrusions 1415, the same applies as what has been mentioned in relation to the plate body 1310 and the obtrusions 1315 of FIGS. 11A-11C.

In the FIGS. 12A-12D, the lighting devices 1401-1404 are shown as comprising a reflective member 906, which may be a semitransparent or switchable mirror. Although such member may be advantageous and preferred, it is noted that this member is not essential for achieving an adequate lighting device.

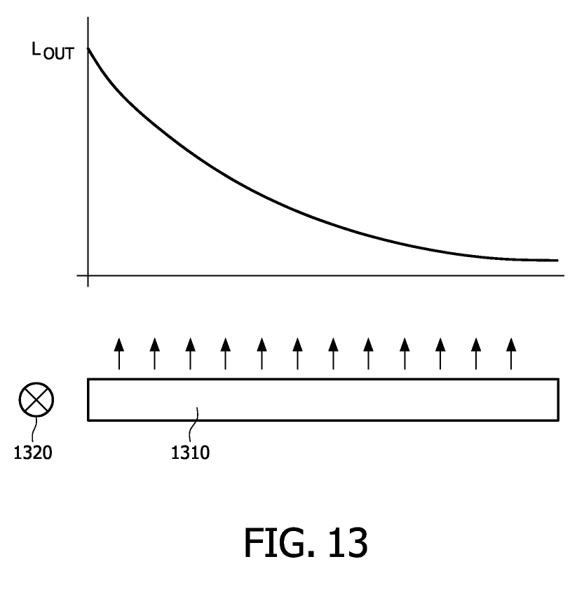

In the above, embodiments of a lighting device have been described, including a plate-shaped light source and a switchable scatterer (see for instance FIGS. 8 and 9A-B), wherein the plate-shaped light source is implemented as a light guide plate with at least one light-generating element arranged at a side. As has also been indicated above, there may be a problem that the luminance at larger distances from the light-generating element may be reduced. This problem is explained with reference to FIG. 13, which shows a graph of which the horizontal axis represents the distance from the light-generating element 1320 in a light guide plate body 1310 (shown below the figure). The vertical axis represents the amount of light produced (i.e. coupled out) at a certain position. This amount may be represented as an absolute intensity per square centimeter, for instance, but it is easier to represent this amount as a percentage of the intensity of the light-generating element. Assuming the outcoupling efficiency p at a certain position (i.e. the percentage of the intensity of the light reaching that position that is coupled out) to be constant with the distance from the light-generating element, it should be clear that at each position i the amount L_{OUT}(i) of light being coupled out and the amount of light INT(i+1) reaching the next position i+1 can be expressed as follows:

L_{OUT}(i)=p·INT(i)

INT(i+1)=(1−p)·INT(i)

It should further be clear that L_{OUT}(i) can thus graphically be represented as a logarithmic curve, as shown in FIG. 13.

If p is relatively small, the decline of L_{OUT}(i) over the extent of the light guide plate body 1310 may be small enough to be unnoticeable or acceptable. However, the surface light intensity of the plate-shaped light source may be relatively small. If p is increased, the surface light intensity of the plate-shaped light source at locations close to the light-generating element (small values of i) will be increased, but unavoidably the surface light intensity of the plate-shaped light source at locations remote from the light-generating element will be increased to a lesser extent, or will even be decreased, depending on the size of the light guide plate body 1310. Thus, the decline of L_{OUT}(i) over the extent of the light guide plate body 1310 will increase.

Thus, although the dot size and dot density is uniform, the light output may be non-uniform, and this may be unacceptable. To a certain extent, this problem can be reduced by making the dot size and/or the dot density non-uniform such as to increase the outcoupling efficiency p as a function of the distance from the light-generating element. Alternatively and/or additionally, it is possible to arrange light-generating elements at opposite sides of the light guide plate body.

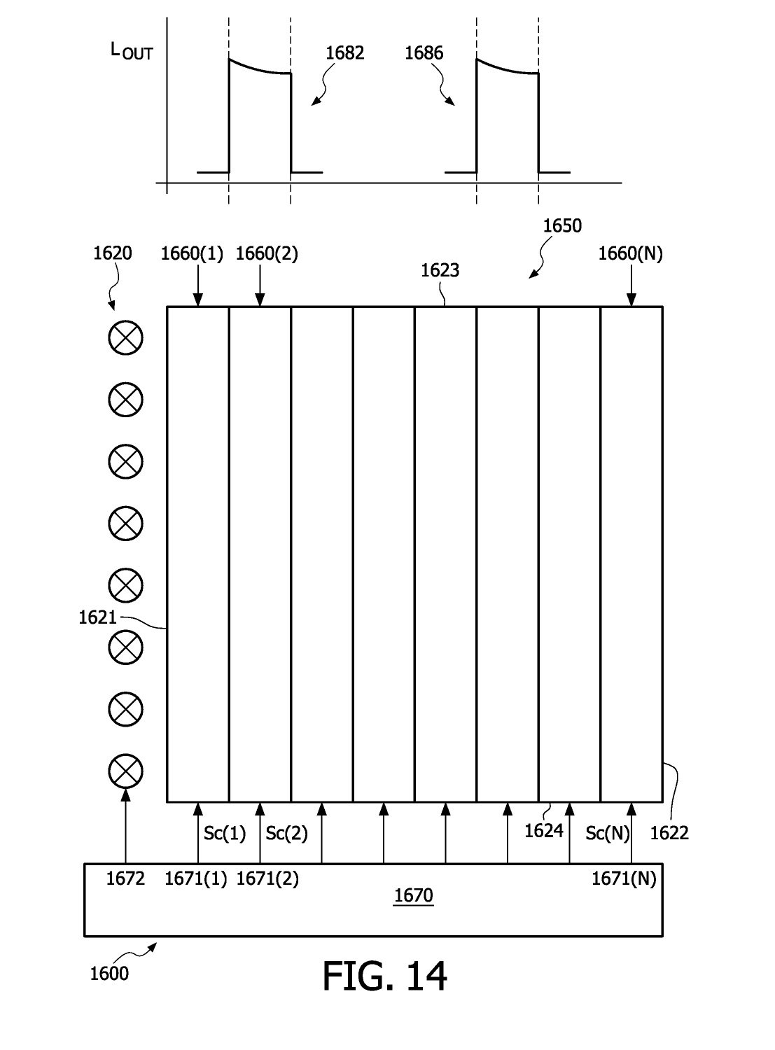

FIG. 14 illustrates another approach according to the present invention. The figure schematically shows a front view of a switchable scatterer 1650 of a lighting device 1600. The lighting device 1600 also comprises a plate-shaped light source, located behind the scatterer 1650 and therefore not visible. The plate-shaped light source is a passive type, for instance implemented as described in the above, with its side illumination 1620 being shown at the lefthand side of the scatterer. A controller for controlling the switching of the switchable scatterer 1650 is indicated at 1670.

According to this aspect of the present invention, the switchable scatterer 1650 is subdivided into a plurality of longitudinal segments 1660, individual segments being identified by the index i, which ranges from 1 to N, N indicating the number of segments. The segments 1660 may mutually have the same width, but this is not essential. The longitudinal dimension of the segments 1660 is directed parallel to a light input side 1621, which is the side where the light generating element or elements 1620 is/are located. For increasing i, the distance from the light generating element(s) 1620 to the longitudinal segment 1660(i) is larger.

The scatterer segments 1660(i) are individually and independently switchable. The controller 1670 has scatterer control outputs 1671(1), 1671(2), . . . 1671(N) coupled to the respective scatterer segments 1660(1), 1660(2), . . . 1660(N). As shown, the controller 1670 may also have a control output 1672 coupled to the light generating element or elements 1620.

The controller 1670 drives the scatterer segments 1660(i) in a time-sequential manner. More particularly, the controller 1670 generates control signals Sc(i) at its respective control outputs 1671(i) for the respective scatterer segments 1660(i) in such a way that one specific scatterer segment 1660(j) is in a scattering state while all other scatterer segments 1660(i), i≠j, are in a non-scattering state. Further, the controller 1670 maintains this state for a predetermined segment maintenance duration τ(j), and then continues to a next state where the subsequent specific scatterer segment 1660(j+1) is in a scattering state while all other scatterer segments 1660(i), i≠j+1, are in a non-scattering state. This is continued until all scatterer segments have been switched briefly to their scattering state, and then the cycle is repeated. In other words, the scattering state is scanned over the scatterer. The cycle duration T can be defined as Στ(j).

The number of scatterer segments will be at least equal to two, and may in principle have any value as desired. In the drawing, the number of segments is shown to be equal to 8.

An advantage of this approach is that the amount of light coupled out of the light guide plate body (e.g. 1310 in FIG. 11A) is very low for those scatterer segments which are in their non-scattering state, and relatively high for the scatterer segment which is in its scattering state. The decline in light intensity as described above will only be observed over the width of the scatterer segment which is in its scattering state, and, depending on this width, such decline may be relatively low even at a relatively high value for p.

Of course, only the scatterer segment(s) which is/are in its/their scattering state has/have an illumination effect, while the other segments practically have no illumination effect. But this situation is momentarily, and lasts for the segment maintenance duration τ. At a time scale larger than the cycle duration T, all segments have partially been in an illumination state, and an illumination ratio can be defined as DR=τ(j)/T. If the cycle duration T is sufficiently short, for instance 10 ms or shorter, the sequential illumination or “scanning illumination” is hardly or not noticeable to the human eye. For each scatterer segment, the average output light amount can be written as DR·L_{OUT}. An important aspect is that this average output light amount can basically be the same for all segments. This is illustrated in the two curves in the graph aligned with the scatterer 1650 in FIG. 14, where one curve 1682 shows the light distribution when the second scatterer segment is in its scattering state (j=2) while another curve 1686 shows the light distribution when the sixth scatterer segment is in its scattering state (j=6). It can be seen that the light intensity of the sixth scatterer segment is at the same level as the light intensity of the second scatterer segment, which is due to the fact that the first to fifth segments hardly “consume” light.

The number of scatterer segments, or the width of the segments, can be selected to improve uniformity. Keeping the light intensity of the light-generating element 1620 constant, the decline per segment can be reduced by increasing the number of scatterer segments.

If the scatterer still suffers from loss of light for scatterer segments further away from the light generating element(s), it is possible to compensate this by having the segment maintenance duration τ(j) increase with increasing distance from the light generating element(s) (i.e. increasing j). It is also possible that the scattering segments do not merely allow for selecting a scattering state or a non-scattering state, but even allow for the efficiency p of the scattering to be controlled. In that case, loss of light can be compensated by having the controller control the segments such that the scattering efficiency p(j) increases with increasing distance from the light generating element(s) (i.e. for increasing j).

In the above explanation, it was assumed that the light intensity of the light-generating element(s) 1620 is constant with time. However, in the embodiment shown, the controller 1670 has a control output 1672 coupled to the light-generating element(s) 1620 for controlling the light intensity of the light-generating element(s) 1620. In that case, loss of light can be compensated by having the controller control the light-generating element(s) 1620 such that the light intensity is increased in proportion with increasing distance between the momentarily scattering segment 1660(j) and the light generating element(s) (i.e. for increasing j).

In the embodiment shown, the light-generating element(s) 1620 is/are arranged along one side 1621 of the lighting device 1600 only, and the scatterer 1650 is subdivided into a first plurality of individually controllable segments 1660 parallel to this one side, i.e. in a vertical direction in the figure. Light is assumed to propagate perpendicularly to this one side 1621 and said individually controllable segments 1660 only, i.e. in a horizontal direction in the figure. Uniformity can be improved by also having light-generating element(s) arranged along the opposite side 1622 of the lighting device 1600. Uniformity can be further improved if the scatterer 1650 is also subdivided into a second plurality of individually controllable segments perpendicular to the first plurality of segments, with second light-generating element(s) arranged along a third side 1623 perpendicular to the said one side 1621 of the lighting device 1600, and possibly further light-generating element(s) arranged along a fourth side 1624 opposite said third side 1623. For the time-sequential control of this second plurality of segments, the same applies as what has been mentioned in respect of the first plurality of segments, it being noted that the time-sequential control of this second plurality of segments may be entirely independent from the time-sequential control of said first plurality of segments.

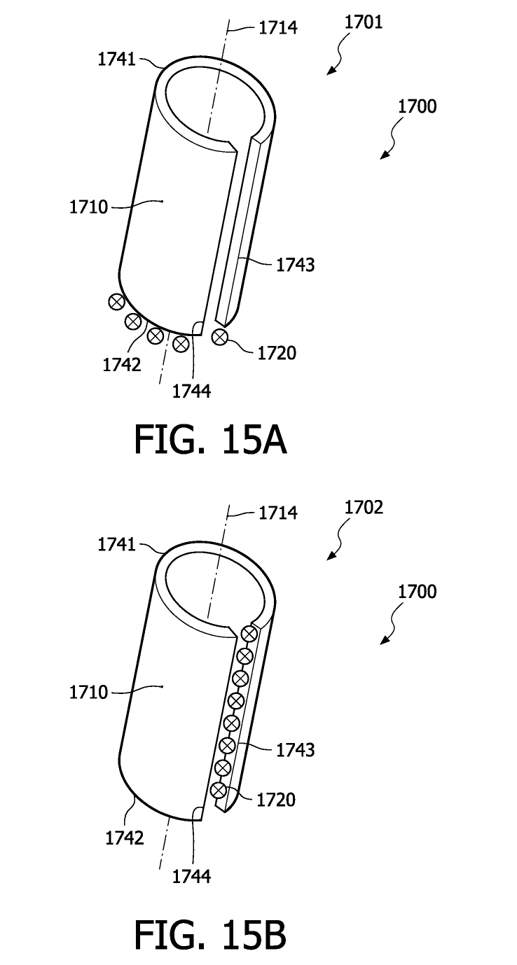

The plate-shaped light source may have a planar shape, as shown in the drawings so far. However, this is not essential, and in fact it is foreseen that special ornamental effects are achieved if the plate-shaped light source has the shape of a curved plate. The curvature may be in one direction only, but may also be in two mutually perpendicular directions (to obtain a pillow-shape or saddle-shape). FIGS. 15A and 15B illustrate extreme examples of lighting devices 1701, 1702 where the plate-shaped light source 1700 comprises a plate body 1710 that is curved over 360° such as to be closed in itself. Although it should be clear that it is not necessary that the radius of curvature is constant, these figures illustrate an example where the plate-shaped light source is curved to form a cylinder having an upper edge 1741 and a lower edge 1742; a longitudinal axis is indicated by reference numeral 1714. The plate body 1710 further has two longitudinal edges 1743, 1744 parallel to the body axis 1714.

The plate-shaped light source 1700 may, again, be an active light source. FIGS. 15A and 15B illustrate embodiments where the plate-shaped light source 1700 is a passive light source. In the embodiment of FIG. 15A, the lower edge 1742 is a light input edge, and (one or more) light-generating elements 1720 are located in line with the lower edge 1742. Alternatively and/or additionally, light-generating elements may also be located in line with the upper edge 1741. An advantage of this embodiment is that the two axial edges 1743, 1744 may be arranged in contact with each other and/or that, in circumferential direction, the light distribution may be seamless. It is noted that the light-generating element 1720 may comprise a planar element.

In the lighting device 1702 of FIG. 15B, the two axial edges 1743, 1744 are light input edges, and (one or more) light-generating elements 1720 are located in between these two edges. An advantage of this embodiment is that the light from the light-generating elements is efficiently used to either enter via the first edge or enter via the opposite edge, so that it is possible to have light input from opposite edges with even one single light-generating element. It is noted that the light-generating element 1720 may comprise a longitudinal element such as a TL lamp.

Summarizing, the present invention provides a lighting device comprising a semi-transparent plate-shaped light source.

The transparent plate-shaped light source may be a passive plate-shaped light source comprising a transparent light guide plate body with two substantially parallel main surfaces, and wherein at least one of the main surfaces is provided with permanent obtrusions.

The obtrusions may be implemented as material portions projecting from the surface and/or as indentations recessed in the surface. The obtrusions may be arranged by sandblasting, preferably in a pattern of dots, wherein the dots may have sizes in the range between 20 and 200 μm, preferably approximately 100 μm, and wherein the dot density may be in the range between 5 and 500 dots/cm².

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

It is noted that the light sources 967 used in conjunction with the plate-shaped light source 950 may emit light of one color only, for instance white, but it is also possible that these light sources 967 emit light with variable color, so that it is possible to have the hiding light match the appearance of the wall; for instance, these light sources may be of RGB type.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope. Features described in relation to a particular embodiment can also be applied to other embodiments described.

1. Lighting device (1401; 1402; 1403; 1404), comprising a semi-transparent plate-shaped light source (1409; 1400).

2. Lighting device (1402; 1403; 1404) according to claim 1, wherein the semi-transparent plate-shaped light source is a passive plate-shaped light source (1400) comprising a transparent light guide plate body (1410) with two substantially parallel main surfaces (1411; 1412), and wherein at least one of the main surfaces (1411; 1412) is provided with permanent obtrusions (1415).

3. Lighting device according to claim 2, wherein the obtrusions (1415) are implemented as material portions projecting from the surface and/or as indentations recessed in the surface.

4. Lighting device according to claim 2, wherein the transparent light guide plate body (1410) has a front surface (1411) to be directed to an observer (204) and a back surface (1412) opposite the front surface, wherein the obtrusions (1415) are arranged in the front surface (1411).

5. Lighting device according to claim 4, further comprising a scattering layer (902) arranged parallel to the light guide plate body (1410) adjacent the back surface (1412) of the light guide plate body (1410).

6. Lighting device according to claim 2, wherein the transparent light guide plate body (1410) has a front surface (1411) to be directed to an observer (204) and a back surface (1412) opposite the front surface, wherein the obtrusions (1415) are arranged in the back surface (1412).

7. Lighting device according to claim 6, further comprising a scattering layer (902) arranged parallel to the light guide plate body (1410) adjacent the front surface (1411) of the light guide plate body (1410).

8. Lighting device according to claim 2, wherein the transparent light guide plate body (1410) has a front surface (1411) to be directed to an observer (204) and a back surface (1412) opposite the front surface, wherein the obtrusions (1415) are arranged in both the front surface (1411) and the back surface (1412).

9. Lighting device according to claim 4, further comprising a reflective member (906) disposed parallel to the plate-shaped light source (1400), facing the back surface (1412) of the light guide plate body (1410).

10. Lighting device according to claim 2, wherein the obtrusions (1415) are arranged by sandblasting.

11. Lighting device according to claim 2, wherein the obtrusions (1415) are arranged in a pattern of dots.

12. Lighting device according to claim 11, wherein the dots have sizes in the range between 20 and 200 μm, preferably approximately 100 μm.

13. Lighting device according to claim 11, wherein the dot density is in the range between 5 and 500 dots/cm².

14. Lighting device according to claim 11, wherein the dot density and/or dot size varies over the surface of the light guide plate body (1410).

15. Lighting device according to claim 14, wherein the passive plate-shaped light source (1400) further comprises at least one light-generating element (1420) arranged near a side face (1313) of the light guide plate body (1410), and
wherein the dot density and/or dot size is adapted such that the light outcoupling efficiency p of the light guide plate increases with increasing distance from the light-generating element (1420).

16. Lighting device (1600) according to claim 1, further comprising a scatterer (1650) arranged parallel to the plate-shaped light source (1409; 1400);
wherein the scattering layer is implemented as a switchable scatterer (1650) subdivided into a plurality of longitudinal segments (1660(i)) mutually parallel to each other, the segments being individually and independently switchable;
wherein the apparatus further comprises a controller (1670) with control outputs (1671) for controlling the respective scatterer segments;
and wherein the controller is adapted to switch the segments to their scattering state in a time-sequential manner.

17. Lighting device according to claim 16, wherein the transparent plate-shaped light source is a passive plate-shaped light source (1400) comprising a transparent light guide plate body (1410) with two substantially parallel main surfaces (1411; 1412), and wherein at least one of the main surfaces (1411; 1412) is provided with permanent obtrusions (1415);
wherein the passive plate-shaped light source (1400) further comprises at least one light-generating element (1420; 1620) arranged near a side face (1313) of the light guide plate body (1410);
wherein the controller keeps each individual segment (1660(i)) in its scattering state for a predetermined segment maintenance duration (τ(i)), wherein the segment maintenance duration (τ(i)) increases with increasing distance from light-generating elements (1620).

18. Lighting device according to claim 16, wherein the transparent plate-shaped light source is a passive plate-shaped light source (1400) comprising a transparent light guide plate body (1410) with two substantially parallel main surfaces (1411; 1412), and wherein at least one of the main surfaces (1411; 1412) is provided with permanent obtrusions (1415);
wherein the passive plate-shaped light source (1400) further comprises at least one light-generating element (1420; 1620) arranged near a side face (1313) of the light guide plate body (1410);
wherein the controller is capable of varying the efficiency p of the scattering of the scatterer segments (1660), such that the scattering efficiency increases with increasing distance from the light-generating element (1620).

19. Lighting device according to claim 16, wherein the transparent plate-shaped light source is a passive plate-shaped light source (1400) comprising a transparent light guide plate body (1410) with two substantially parallel main surfaces (1411; 1412), and wherein at least one of the main surfaces (1411; 1412) is provided with permanent obtrusions (1415);
wherein the passive plate-shaped light source (1400) further comprises at least one light-generating element (1420; 1620) arranged near a side face (1313) of the light guide plate body (1410);
wherein the controller has a light control output (1672) coupled to the light-generating element(s) (1620) for controlling the light intensity of the light-generating element(s) (1620);
and wherein the controller is capable of varying the light intensity of the light-generating element(s) in correspondence with the time-sequential control of the scatterer segments (1660), such that the light intensity is increased in proportion with increasing distance between the momentarily scattering segment and the light generating element(s).

20. Lighting device according to claim 16, wherein the switchable scatterer (1650) is also subdivided into a second plurality of individually controllable segments perpendicular to the first plurality of segments, wherein the controller is adapted to also switch the segments of the second plurality to their scattering state in a time-sequential manner.

21. Lighting device (1401) according to claim 1, wherein the transparent plate-shaped light source (1409) is an active plate-shaped light source.

22. Lighting device (1701, 1702) according to claim 1, wherein the plate-shaped light source (1700) comprises a curved plate body.

23. Lighting device (1701) according to claim 22, wherein the plate-shaped light source (1700) is a passive light source comprising a plate body (1710) having a first axial end edge (1741), a second axial end edge (1742), and two longitudinal edges (1743, 1744) substantially parallel to a longitudinal axis (1714);
and wherein the plate-shaped light source (1700) further comprises at least one light-generating element (1720) located adjacent at least one of the axial end edges (1742).

24. Lighting device (1702) according to claim 22, wherein the plate-shaped light source (1700) is a passive light source comprising a plate body (1710) having a first axial end edge (1741), a second axial end edge (1742), and two longitudinal edges (1743, 1744) substantially parallel to a longitudinal axis (1714);
and wherein the plate-shaped light source (1700) further comprises at least one light-generating element (1720) located adjacent at least one of the longitudinal edges (1743, 1744).

25. Lighting device (1702) according to claim 24, wherein the plate body (1710) is curved over almost 360° so that its two longitudinal edges (1743, 1744) are located close to each other, with said at least one light-generating element (1720) located in between said longitudinal edges (1743, 1744).
